(19) United States
(12) Patent Application Publication
(10) Pub. No.: US 2025/0115283 A1
(43) Pub. Date: Apr. 10, 2025

(54) RAILROAD CROSSING BLOCKAGE DETECTION AND NOTIFICATION SYSTEM

(71) Applicant: RAPIDSOS, INC., New York, NY (US)

(72) Inventors: Zachery LaValley, Arlington, MA (US); Daniel Richard Seidberg, Manlius, NY (US); Conor Fucci, Brooklyn, NY (US)

(21) Appl. No.: 18/759,647

(22) Filed: Jun. 28, 2024

Related U.S. Application Data
(60) Provisional application No. 63/543,453, filed on Oct. 10, 2023.

(51) Int. Cl. B61L 23/30

(52) U.S. Cl. CPC B61L 23/30

(57) ABSTRACT

A railroad crossing blockage detection and notification system gathers emergency call data and/or infrastructure sensor data and uses the data to generate a blockage score that is representative of a likelihood of a railroad blockage at a railroad crossing. The system may include and use a machine learning model to generate the blockage score. Using historical train collision data, the machine learning model may be trained on emergency call data and/or on infrastructure sensor data available in proximity to railroad crossing. The system may receive current emergency call data and/or infrastructure sensor data, may apply the data to the machine learning model to generate a likelihood of a blockage, and may notify emergency communication centers (ECCs), network operations centers (NOCs), emergency responders, and/or train systems of the potential blockage. In response to a potential blockage, a train may be slowed down or stopped to reduce the likelihood of a collision.

### CROSS-REFERENCE TO RELATED APPLICATIONS

The present application claims priority to U.S. Provisional Patent Application No. 63/543,453, filed on Oct. 10, 2023, which is hereby incorporated by reference in its entirety.

### FIELD OF THE DISCLOSURE

The present disclosure relates generally to public and private infrastructure systems, and more particularly, apparatuses, systems, and methods for detecting railroad crossing blockages and notifying emergency communications centers of potential blockages.

### BACKGROUND

Infrastructure systems encounter problems and emergencies on a daily basis. Infrastructure systems include both public and private infrastructure systems. Public infrastructure refers to governmentally developed, owned and operated infrastructure facilities, systems, and structures that are open to the general public for use. Whereas private infrastructure refers to any infrastructure not owned by or dedicated to a governmental or public entity or authority. In some situations, infrastructure systems may be a combination of public and private infrastructure. That is, some portions of infrastructure systems may be public whereas portions may be privately owned.

Examples of infrastructure systems include, but are not limited to, transport infrastructure such as roads, rail, cable, and shipping ports; aviation infrastructure such as air traffic control technology; rail transport such as trackage, signals, electrification of rails; road transport such as roads, bridges, tunnels; critical infrastructure such as assets required to sustain human life; energy infrastructure such as transmission and storage of fossil fuels and renewable sources; electrical grid such as transmission and distribution stations, power lines, power plants, etc.; hazardous waste such as disposal and handling; information and communication infrastructure such as systems of information storage and distribution; solid waste such as generation, collection, management of trash, garbage and recycling; water infrastructure for the distribution and maintenance of water supply; wastewater infrastructure for disposal and treatment of wastewater, etc.

Many of these infrastructure systems may encounter incidents or emergencies that involve not only the specific infrastructure system, but multiple facets of infrastructure systems that may need to work together to resolve the incidents or emergencies. In one example, transport infrastructure such as railroads may be used to transport hazardous material. If a train derailment occurs for a train carrying hazardous materials, the emergency may involve hazardous material containment and management, in addition to railroad issues, and the event could present dangers of toxicity to the emergency responders as well as the surrounding community where the derailment occurred. Time is of the essence in responding to such dangers, but prevention of such dangers would be preferable.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing.

FIG. 1 is a diagram illustrating a railroad crossing blockage detection and notification system, in accordance with embodiments of the disclosure.

FIGS. 2A-2D are diagrams showing a railroad crossing environment, in accordance with embodiments of the disclosure.

FIG. 3 is a block diagram showing an emergency data manager that is operable to perform a process for determining a likelihood of a blockage of a railroad crossing, in accordance with aspects of the disclosure.

FIG. 4 is a block diagram showing an emergency data manager that is operable to perform a process for identifying railroad crossings that are blocked from a train stoppage, in accordance with aspects of the disclosure.

FIG. 5 is a block diagram showing an emergency data manager that is operable to perform a process for generating impact zone notifications, in accordance with aspects of the disclosure.

FIG. 6 is a flow diagram of a process for determining a likelihood of a railroad blockage, in accordance with aspects of the disclosure.

FIG. 7 is a flow diagram of a process for determining a likelihood of a railroad blockage, in accordance with aspects of the disclosure.

FIG. 8 is a flow diagram of a process for providing railroad crossing blockage notifications from a train stoppage, in accordance with aspects of the disclosure.

FIGS. 9A and 9B are example diagrams of GUIs that may be displayed at an ECC to graphically communicate potential blockages of railroad crossings, in accordance with aspects of the disclosure.

FIGS. 10A and 10B are example diagrams of GUIs that may be displayed at a NOC to graphically communicate potential blockages of railroad crossings, in accordance with aspects of the disclosure.

FIG. 11 is a diagram of a train control interface that may be part of a train control system that is used to accelerate, decelerate, start, and stop a train, in accordance with aspects of the disclosure.

FIG. 12 is an example of a map view that shows a simplified example of a notification of impact zones along a railroad that travels along a number of jurisdictional boundaries, in accordance with aspects of the disclosure.

### DETAILED DESCRIPTION

Briefly, the present disclosure provides apparatuses, systems, and methods that provide hardware and technology that, among other things, provide a practical application of hardware and technology to solve a problem of dangerous conditions that may arise in infrastructure systems. Such infrastructure systems include public infrastructure, private infrastructure and combinations thereof. One example of dangerous conditions that may arise is a railroad blockage at a railroad crossing. As reported by Operation Lifesaver, the Federal Railroad Administration cites nearly 2,000 (and often more) train collisions every year for the past two decades. Prior to 2004, there were 3,000 (or significantly more) train collisions every year, for several decades. Annually, these train collisions result in several hundred fatalities, several hundred more injuries, property damage, trauma, train stoppages, and cargo delivery delays. Some of these results could be reduced or avoided, if railroad blockages could be detected and if relevant parties could be notified of the blockage in advance.

As used herein a railroad crossing is a location where a public highway, road, street, or private roadway, including associated sidewalks and pathways, crosses one or more railroad tracks at the level or approximately at the same plane (at grade) of the railroad tracks.

In accordance with embodiments of the disclosure, a railroad crossing blockage detection and notification system gathers emergency call data (e.g., data from one or more emergency calls and/or infrastructure sensor data (e.g., data from one or more relevant sensors) and uses the data to generate a blockage score that is representative of a likelihood of a railroad blockage at a railroad crossing. The detection and notification system may include and use a machine learning model to generate the blockage score. Using historical train collision data, the machine learning model may be trained on emergency call data (e.g., locations and timestamps of emergency calls around train collisions) and/or on infrastructure sensor data (e.g., pipe sensors, pressure sensors, cameras, power line sensors, train location sensors) available in proximity (e.g., within a 500 meter radius) to a railroad intersection. The detection and notification system may receive emergency call data and/or infrastructure sensor data, may apply the data to the machine learning model to generate a likelihood of a blockage, and may notify emergency communication centers (ECCs), network operations centers (NOCs), emergency responders, and/or train systems of the potential blockage. In response to a potential blockage and to avoid a possible collision, a train may be slowed down to allow time for the blockage to be cleared without expending the resources of fully stopping and restarting the train. The train may also be stopped. In some implementations, the detection and notification system may query one or more databases for the speed length, and/or weight of the train (or other potentially relevant information about the train to determine approximately how much time is needed for the train to stop, and train control signals (or suggestions) are transmitted to the NOC and/or train to slow or stop the train to reduce the likelihood of train collision at the railroad crossing.

In accordance with embodiments of the disclosure, the railroad crossing blockage and notification system may be operable to determine, estimate, and identify railroad crossings that are blocked by a train stoppage. The length of a train may extend up to 1-2 miles long, so a train stopped in an urban area may result in multiple railroad crossings being blocked by the train. The blockage and notification system may query information about the train to determine the train length, detect at least one blocked railroad crossing, identify additional blocked railroad crossings, and notify various parties of the blockages. For example, the detection and notification system may notify an ECC, a NOC, emergency responders, and/or navigation service servers. By notifying navigation service servers or providers (e.g., Google Maps, Apple Maps, Waze, etc.), emergency responders and/or the general public may be better able to avoid a route that is blocked by a train stoppage. In the case of emergency responders, this notification may save several minutes off of the time that might otherwise be wasted backtracking from a blocked railroad crossing. In emergency response, saving minutes may result in saving lives, reducing the level of injury, reducing property damage (e.g., fire), and reducing the risk to the lives of the emergency responders (e.g., getting to a fire earlier may be safer), for example.

In accordance with embodiments of the disclosure, the railroad crossing blockage detection and notification system may be operable to provide impact zone notifications for a train as the train traverses the jurisdictional boundary of an ECC. The blockage and notification system may provide notifications using one or more interfaces including, but not limited to, graphical user interfaces (GUIs) provided to service professionals at an ECC and/or at a NOC. The impact zone may provide a level of impact that a train stoppage or collision might have within particular regions of a jurisdictional boundary. For example, an accident with hazardous materials may have a significantly higher impact on a community if the accident occurs next to a stream, river, lake, other natural resource, or highly populated region—as compared to occurring out in a desert field. As another example, an accident that occurs near the outer regions of two or more ECCs may be removed from emergency resources, which may have a greater impact on fatalities and injuries—as compared to occurring near emergency responder locations or resources. The notifications of the impact zones may be graphically visualized as heat maps or with text-based indicators (e.g., high—H, medium—M, low—L, etc.) on a map to facilitate communication of the information to ECC or NOC operators, for example.

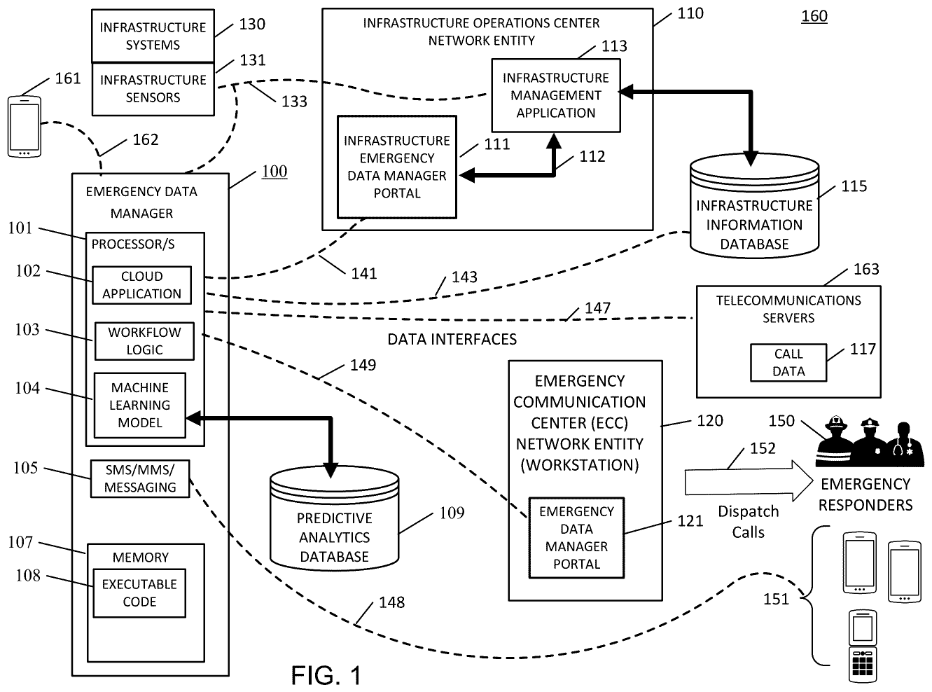

Potential advantages of the disclosed railroad crossing blockage detection and notification system include reduced train collisions, reduced fatalities, reduced property damage, and reduced delays in shipped goods. Overall, embodiments of the disclosure improve the technology area of emergency response systems and rail management systems. Various embodiments are described hereafter and represented in FIGS. 1-12.

FIG. 1 is a diagram illustrating a railroad crossing blockage detection and notification system 160 that is operable to detect and/or predict blockages of railroad crossings based on emergency call data and/or infrastructure sensor data, in accordance with aspects of the disclosure. As used herein, infrastructure sensors may include sensors that are implemented for the purpose of sensing infrastructure and may also include sensors that are proximal to and capable of sensing infrastructure even if infrastructure sensing is not the intended purpose of the sensor(s). Railroad crossing blockage detection and notification system 160 includes an emergency data manager 100 in communication with various infrastructure systems 130, infrastructure sensors 131, various emergency communication centers (ECCs) 120, mobile devices 161, and emergency responder devices 151. ECCs include Public Safety Answering Points (PSAPs) that receive emergency calls (e.g., 911 calls) and handle police, fire, and medical emergencies. An ECC may also include a network operations center (NOC) that guides operations of trains or portions of railroads to support and maintain train mobilization.

The emergency data manager 100 includes at least one processor 101 and non-transitory, non-volatile memory 107 that stores executable code 108. The executable code 108 (also referred to as “executable instructions,” “code,” “software code,” etc.), when executed by the at least one processor 101, provides a cloud application 102, workflow logic 103, and a machine learning model 104. A short-message-service (SMS) multimedia message service (MMS) module 105 may also be present and may be implemented as hardware, software, or a combination thereof to provide SMS, MMS, or rich communication services (RCS).

The at least one processor 101 may be implemented as one or more microprocessors, such as a system on a chip (SoC), or using one or more, or combinations of, ASICs, FPGAs, microcomputers, microcontrollers, digital signal processors, central processing units, state machines, logic circuitries, and/or devices that manipulate signals based on operational instructions. Among other capabilities, the at least one processor 101 is configured and operative to fetch and execute the computer-readable instructions (e.g., executable code 108) stored in the memory 107. For example, the executable code 108, when executed by the at least one processor 101 renders the processor operative to provide a kernel, libraries (e.g., application programming interfaces or “APIs”), an application layer or “user space” within which the various applications are executed, and an IP protocol stack. The executable code 108 for cloud application 102, when executed by the at least one processor 101, may also provide the workflow logic 103, machine learning model 104, and SMS/MMS messaging module 105. The at least one processor 101 is operative to perform the various methods of operation of an emergency data manager 100 as described herein including, but not limited to, the methods of operation disclosed herein and described with respect to various flowcharts and diagrams provided in the drawings.

The infrastructure system 130 may be any infrastructure system such as systems related to transport infrastructure such as roads, rail, cable, and shipping ports; aviation infrastructure such as air traffic control technology; rail transport such as trackage, signals, electrification of rails; road transport such as roads, bridges, tunnels; critical infrastructure such as assets required to sustain human life; energy infrastructure such as transmission and storage of fossil fuels and renewable sources; electrical grid such as transmission and distribution stations, power lines, power plants, etc.; hazardous waste such as disposal and handling; information and communication infrastructure such as systems of information storage and distribution; solid waste such as generation, collection, management of trash, garbage and recycling; water infrastructure for the distribution and maintenance of water supply; wastewater infrastructure for disposal and treatment of wastewater, etc.

The infrastructure system 130 includes various infrastructure sensors 131 that provide sensor data related to the infrastructure system 130 to a point of control, such as an infrastructure operations center which includes one or more network entities such as infrastructure operations center (IOC) network entity 110. The sensor data may include, but is not limited to, power sensor data, moisture sensor data, flow sensor data, pressure sensor data, camera data, proximity data, and (train) location data, for example. The IOC network entity 110 includes an infrastructure management application 113 that is operable to communicate with the infrastructure system 130 and to receive data from the infrastructure sensors 131 through data interface 133, for example. One specific example of an IOC is a network operations center (NOC) that receives train/rail-related sensor data and that supports train/rail-related operations.

A train company or NOC may have insight to (or oversight of) some of the contributing factors that may lead to a train derailment. For example, poor track maintenance or engineer error (e.g., operating a train at speeds that are too high) may be tracked within the infrastructure operations center network entity 110 and provided to emergency data manager 100. In some implementations, internal sources of data (e.g., data tracked by a train company or NOC) may be combined with emergency call data and/or sensor data to build a more complete view of an infrastructure situation. In one embodiment, at least some of the internal data (e.g., maintenance records) are provided to a machine learning model or AI model and used to assess and provide notification of a risk of collision or derailment.

The cloud application 102 is operable to provide single tenant, or multi-tenant cloud applications for emergency management to multiple IOC network entities and for a variety of different infrastructure systems. The cloud application 102 provides an instance of the application via an infrastructure emergency data manager (EDM) portal 111, which provides a graphical user interface (GUI) to the operator of the IOC network entity 110. The IOC network entity 110 may be, for example, a workstation, laptop computer, etc. Each infrastructure system 130 may have multiple IOC network entities 110 operated by different operators and each operator may execute an instance of the cloud application 102 via the infrastructure EDM portal 111 (e.g., a GUI). In one embodiment, various infrastructure systems 130 may be operable to provide sensor data from infrastructure sensors 131 to emergency data manager 100 through data interface 133 (e.g., API query, API push notification, etc.) to support predictive analytics for determining the likelihood of a blockage of a railroad at a railroad crossing.

In some embodiments, the infrastructure EDM portal 111 may be operatively coupled to the infrastructure management application (IMA) 113 via an application programming interface (API) API 112 to receive data from the infrastructure sensors 131 or to receive other information and data from the IMA 113. The IMA 113 may also be operatively coupled to an infrastructure information database 115 that contains information related to the infrastructure. The infrastructure EDM portal 111 operates via a data interface 141 to the cloud application 102 and may be a web socket connection over a TCP/IP connection or may be an API data interface in some embodiments.

The emergency data manager 100 is operative to receive data from mobile devices 161 that have placed emergency calls or texts to an ECC by, for example, dialing 911, or equivalent 112, etc. When one of mobile devices 161 places an emergency call to an ECC the mobile device 161 sends hybrid location data and timestamp data over a data interface 162 which may be an Internet connection. The hybrid location data, timestamp data, and device identifier (e.g., collectively, call data 117) may be received from the mobile devices 161 by one or more telecommunications servers 163, and the one or more telecommunications servers 163 may be configured to provide the call data 117 to the emergency data manager 100 over a data interface 147, for example. The emergency data manager 100 receives the hybrid location data (which may include mobile devices 161 GPS location and mobile devices 161 generated/calculated location) and sends the location information and mobile device identifier (e.g., the mobile device telephone number) to an ECC relevant to the mobile device's location when calling for emergency help. The cloud application 102 is operatively coupled to various ECCs. For example, the cloud application 102 provides an instance of the application to an ECC network entity 120 via an EDM portal 121 (e.g., with a GUI) executing on a web browser. The data interface 149 may be a web socket connection over a TCP/IP connection. Multiple ECCs may operate multiple instances of the cloud application 102 and each network entity may display and operate the EDM portal GUI 121.

When the cloud application 102 receives a location and telephone number from a mobile device 161 when an emergency call is placed, a workflow logic 103 begins operation and forms an emergency message or emergency alert that is sent from the emergency data manager 100 to the relevant ECC based on the location of the caller and the jurisdiction of the ECC. The workflow logic 103 sends the emergency alert to the EDM portal GUI 121 over the data interface 149. The mobile device 161 location information received and handled by the emergency data manger 100 is performed independently from the emergency call routing (e.g., independently from the telephony network routing) and does not involve the SS7 or C7 network signaling of the telephony network. Therefore, the mobile device 161 location and telephone number may be displayed on the EDM portal 121 prior to the ECC having received and answered the actual call.

For infrastructure emergencies, there are several ways in which an ECC may be informed of the situation. In one case, a bystander who witnesses an emergency may call in to the ECC by, for example, dialing 9-1-1. Another way in which the ECC may be informed is from the IOC network entity 110. An operator, using the infrastructure EDM portal 111 may create an incident by entering appropriate identification information into the GUI which is then sent to the emergency data manager 100 and then to the ECC EDM portal 121. From there, an ECC operator may perform dispatch functions to dispatch emergency responders 150 to the location of the incident. In both cases, the emergency data manager 100 may detect patterns in emergency calls and/or patterns in infrastructure sensor data to predictively determine that an incident has occurred (e.g., a car accident that resulted in a railroad crossing blockage).

Because infrastructure emergencies may require special knowledge and special handling, the cloud application 102 may also be operatively coupled to the infrastructure information database 115 via a data interface 143. The data interfaces may be APIs in some embodiments.

The cloud application 102 may be operative to determine a likelihood of a blockage of a railroad at a railroad crossing based on data from the infrastructure sensors 131 and/or based on the call data 117, in accordance with aspects of the disclosure. The cloud application 102 may receive the sensor data directly, in some implementations, or may receive data from via the infrastructure EDM portal 111 through API 112. The call data 117 may be received directly from mobile devices 161 or may be received via telecommunications servers 163 through data interface 147. Cloud application 102 may include one or more modules, processes, and/or algorithms that enable emergency data manager 100 to use infrastructure sensor data and/or call data 117 to determine whether a crossing is blocked, to verify the potential blockage, and/or to provide notifications to IOC network entity 110 and/or ECC network entity 120 of the potential blockage.

Cloud application 102 and/or emergency data manager 100 may use machine learning model 104 to determine the likelihood of a railroad crossing blockage based on infrastructure sensor data and/or call data 117, according to an embodiment. The machine learning model 104 uses data from the infrastructure sensors 131 (e.g., received from the infrastructure EDM portal 111), uses call data 117, and correlates the data to predict or identify infrastructure emergencies and/or railroad blockages using a combination of sensor data and call data 117, according to an embodiment.

The machine learning model may be trained using historical train collisions and general train traffic data along the lines and railroad crossings where collisions have occurred. The machine learning model 104 may be trained from historical call data and/or historical sensor data that was generated around the time of historical train collisions and that was generated in proximity to railroad crossings (that both did and did not have collisions). The predictive analytics database 109 may be used to store historical collision data, call data, and/or sensor data and may be used for training machine learning model 104. The predictive analytics database 109 may be used to store blockage predictions as reports and other information. The predictions may be sent as notifications, blockage scores, or risk categories to the infrastructure EDM portal 111, to the ECC EDM portal 121, to train control systems, to navigation service servers, and/or to emergency responders 150 (e.g., emergency responder devices 151 via data interface 148), in accordance with various embodiments of the disclosure.

As used herein, components may be “operatively coupled” when information can be sent between such two components, even though there may be one or more intermediate or intervening components between, or along the connection path. Operative coupling may exist between engines, system interfaces or components implemented as software or firmware executing on a processor and such “software coupling” may be implemented using libraries or other software interfacing techniques as appropriate. Such libraries or APIs provide operative coupling between various software implemented components in FIG. 1.

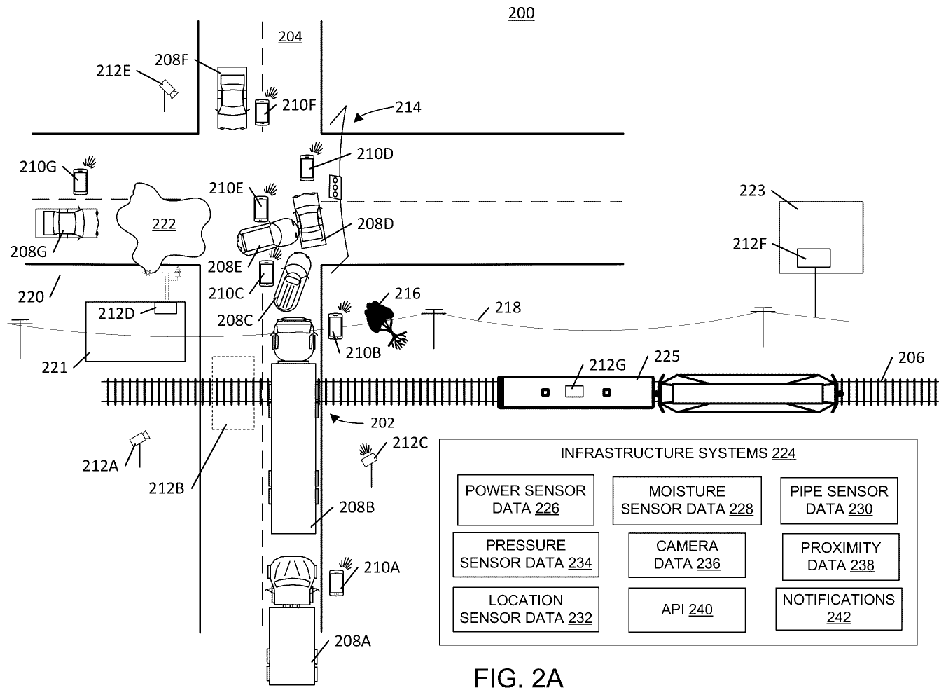

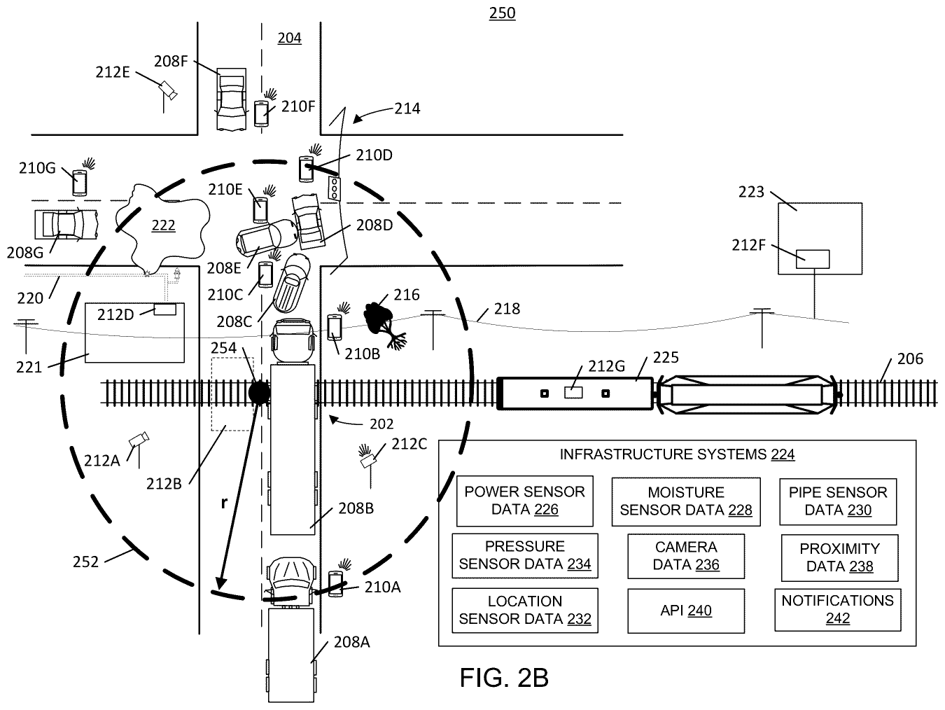

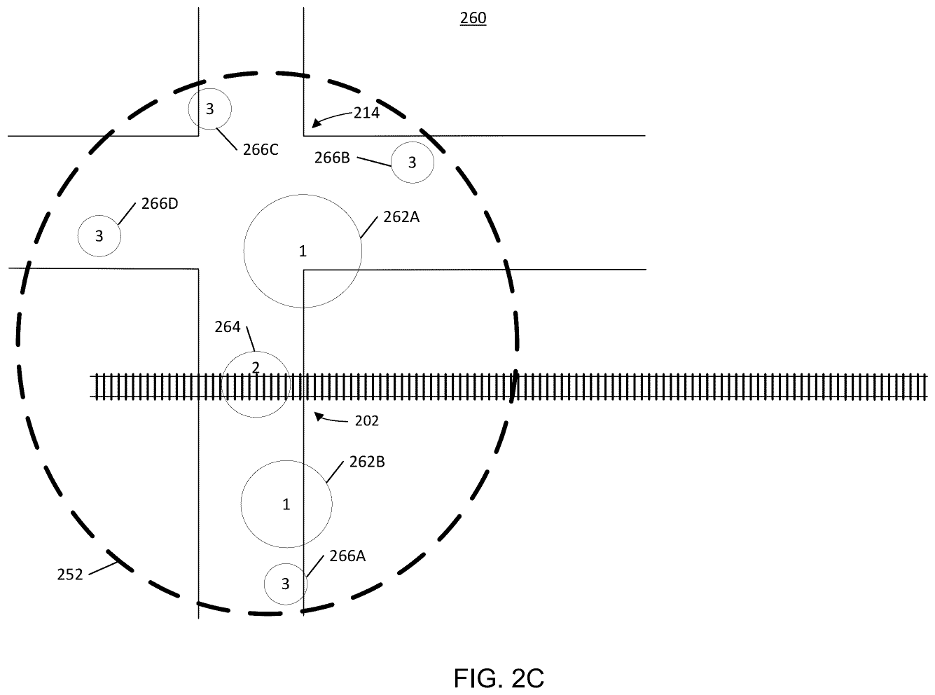

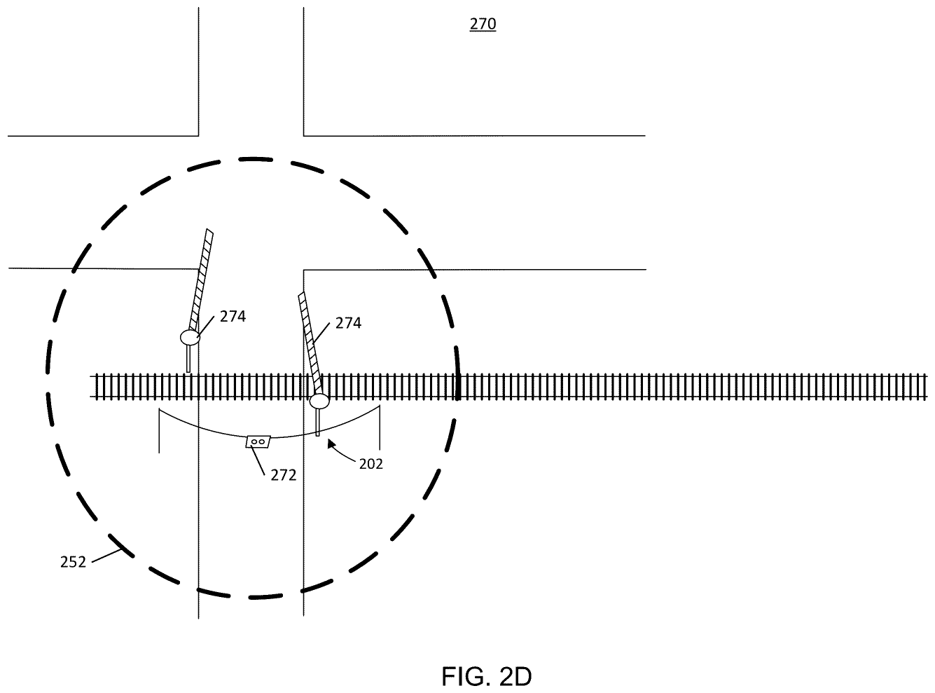

FIGS. 2A, 2B, 2C, and 2D are top-view diagrams of railroad crossing environments that may generate emergency call data and infrastructure sensor data that may be used by an emergency data manager (e.g., emergency data manager 100) to perform railroad blockage detection and notification, in accordance with aspects of the disclosure. FIG. 2A illustrates a diagram of a railroad crossing environment 200 that illustrates examples of incidents occurring proximate to a railroad crossing 202 that may be detectable using emergency call data and/or infrastructure sensor data. Railroad crossing environment 200 includes the railroad crossing 202, a road 204, a railroad 206, a number of vehicles 208, mobile devices 210, and (infrastructure) sensors 212, according to an embodiment.

The railroad crossing 202 includes an intersection of road 204 with the rail 206. The road 204 may be single-lane, double-laned, multi-laned, paved, unpaved, urban, rural, public, private, or various other types of pathways made to support vehicular travel. The railroad crossing 202 may be positioned proximate to (e.g., within 500 meters) various obstacles that may cause a blockage of the railroad 206 at the railroad crossing 202. For example, an intersection 214 may be within several hundred meters of the railroad crossing 202 and may have car accidents that cause a blockage of the railroad crossing 202. One or more trees 216 may be positioned near the railroad crossing 202 and near one or more power lines 218, which could cause a blockage of the railroad crossing 202. One or more pipes 220 may be positioned proximate to the railroad crossing 202 and may cause spills that induce accidents that lead to blockages of the railroad crossing 202.

In a first example scenario, a car accident at intersection 214 causes the vehicle 208B to block the railroad 206 at the railroad crossing 202. Vehicles 208 may be individually referenced as vehicle 208A, 208B, 208C, 208D, 208E, 208F, and 208G. Mobile devices 210 may be individually referenced as mobile device 210A, 210B, 210C, 210D, 210E, 210F, and 210G. In the car accident, vehicle 208E has collided into vehicle 208D at the intersection 214. The collision between the vehicles 208D and 208E may be caused by liquid 222 that has pooled or puddled in the road 204 near the intersection 214. The liquid 222 may be a result of damage to the pipe 220. The vehicle 208C stopped short of the intersection 214, based on the stoppage of the vehicle 208D. The stoppage of the vehicle 208C has caused the vehicle 208B to become a blockage of the railroad 206 at the railroad crossing 202. Additional vehicles in the vicinity may be observers of the car accident and/or may block or interrupt clearing the blockage of the railroad crossing 202. For example, the vehicle 208A may be parked closely behind the vehicle 208B, so the vehicle 208B cannot back up to unblock the railroad crossing 202. The vehicles 208F and 208G may be stopped at the intersection 214, due to the collision of the vehicles 208D and 208E.

In this first example scenario, each of the vehicles 208 corresponds with one of mobile devices 210 that has called or that may call 911 to report the car accident. The 911 calls from the mobile devices 210 provide a time pattern (through timestamp data) and a location pattern (through hybrid location data) proximate to the railroad crossing 202. The emergency data manager (e.g., emergency data manager 100) may use the time pattern and the location pattern of the mobile device calls to 911 to predict, identify, or determine the likelihood of a blockage of the railroad crossing 202, based on patterns (e.g., from historical train collisions) that the machine learning model 104 has been trained on.

In this first scenario, railroad crossing environment 200 includes various infrastructure sensors 212 that may be used by the emergency data manager to predict, identify, or determine the likelihood of a blockage at the railroad crossing 202, according to an embodiment. Individually, infrastructure sensors 212 may include an infrastructure sensor 212A that is implemented as a camera oriented towards railroad crossing 202, an infrastructure sensor 212B that is implemented as a pressure sensor under the railroad 206 at railroad intersection 202, an infrastructure sensor 212C that is implemented as a proximity sensor (e.g., light-based, acoustic-based, etc.), an infrastructure sensor 212D that is implemented as a pressure sensor (or flow sensor) for pipe 220, an infrastructure sensor 212E that is implemented as a camera for intersection 212, an infrastructure sensor 212F that is implemented as a power monitoring sensor, and an infrastructure sensor 212G that is implemented as a location sensor (e.g., GPS), according to embodiments of the disclosure. The infrastructure sensors 212 may be positioned at various locations in the railroad crossing environment 200. The infrastructure sensor 212A may be oriented to capture camera data at the railroad crossing 202. The infrastructure sensor 212B may be positioned under the railroad 206 at the railroad crossing 202. The infrastructure sensor 212C may be positioned near the railroad crossing 202 to determine if a blockage is positioned within the railroad crossing 202. The infrastructure sensor 212D may be coupled to a pump and/or the pipe 220 and maybe housed in or on a building 221, for example. The infrastructure sensor 212E may be positioned near the intersection 214 and maybe oriented to capture images of the intersection 214. The infrastructure sensor 212F maybe electrically coupled to the power line 218 and maybe housed in a power station 223 for monitoring the power line(s) 218 and for generating power sensor data 226, according to an embodiment. The infrastructure sensor 212G may be coupled to a train 225 and may be configured to provide train location data 232 to one or more infrastructure systems 224, according to an embodiment.

The emergency data manager may use the sensor data alone or in combination with the emergency call data to determine a likelihood of a blockage of the railroad 206 at the railroad crossing 202, in accordance with aspects of the disclosure. The emergency data manager may be communicatively coupled with one or more infrastructure systems 224 to receive the various sensor data using API 240 and/or from notifications 242, for example. The sensor data around various railroad crossings in the country may be collected and analyzed during times when train collisions occurred as well as during times when train collisions did not occur. The machine learning model 104 may be trained based on the sensor data to determine the likelihood of a blockage at a railroad crossing that is based on the sensor data from one or more infrastructure sensors. The machine learning model 104 may be trained on a combination of the emergency call data and the sensor data that is associated with railroad crossings. The machine learning model 104 may be trained on the combination of emergency call data and the sensor data that was generated before, during, and after a train collision in order to tune the machine learning model to patterns and characteristics of these data types for environmental conditions that correlate with train collisions.

In a second example scenario, the tree 216 falls and takes down the power line 218 next to the railroad crossing 202, the downed power line 218 may land on or near the vehicle 208 B. A downed power line may cause vehicle 208B to block (e.g., stop in or near) the railroad crossing 202. If a downed power line impedes the mobility of the vehicle 208B, it is likely that the driver will exit vehicle 208B for safety. As a result, vehicle 208A may also be stopped near railroad crossing 202. 911 calls from mobile devices 210B and 210A, in addition to sensor data from infrastructure sensor 212A, 212B, 212C, and 212F may generate sensor data relevant to the blockage of railroad crossing 202. The emergency data manager may use the emergency call data and the sensor data from similar example scenarios to determine a likelihood of a blockage of railroad crossing 202, in accordance with aspects of the disclosure. In a scenario like this, the emergency data manager may determine that a railroad crossing blockage is more likely than not or that a railroad crossing blockage has a medium or high likelihood.

FIG. 2B Illustrates example diagram of a railroad crossing environment 250, in accordance with aspects of the disclosure. Railroad crossing environment 250 includes a geofence 252 around a center 254 of railroad crossing 202. The geofence 252 may be a circle and may have a radius r that defines a distance from the center 254 for gathering emergency call data and infrastructure sensor data for the determination of the likelihood of a blockage of railroad crossing 202, according to embodiments of the disclosure. The radius r may be 500 meters, in one implementation. The radius r may be selectively increased or decreased based on the location of the railroad crossing 202. For example, in a highly urban area, the radius r may be decreased to tens of meters. However, in a more rural area, the radius r may be increased to capture sensor data and emergency call data from a greater surrounding area (e.g., a 1000 meters) of railroad crossing 202. In some implementations, the geofence 252 is circular, rectangular, a square, triangular, another polygon, or some other shape, according to various embodiments. The geofence 252 may be auto-generated (e.g., based on machine learning model results), may be manually created, or may be auto-generated and manually updated, according to various embodiments.

FIG. 2C illustrates an example diagram of a railroad crossing environment 260 that shows example patterns of the locations of emergency call data that may be used to characterize, predict, or otherwise determine the likelihood of a blockage of the railroad crossing 202, according to an embodiment. A first pattern 262 may include an emergency call locations 262A that is located at the intersection 214 and may have an emergency call location 262B that is located on the other side of railroad 206. The first pattern 262 may be used to increase the likelihood of a blockage of railroad crossing 202, as it may indicate an accident at the intersection 214 and an issue related to railroad crossing 202. A second pattern 264 may include a single emergency call location made on or very near (e.g., within 2 meters) the railroad 206 in the railroad crossing 202. An emergency call made in accordance with the second pattern 264 may be provided a greater weight or a higher likelihood of a blockage of railroad crossing 202. A third pattern 266 may include emergency call location 266A, emergency call location 266B, emergency call location 266C, and emergency call location 266D that cumulatively constitute the third pattern 266. The third pattern 266 may be indicative of issues (e.g., car accidents and backed up traffic) on both sides of the railroad 206, which may be an indication of a blockage of the railroad crossing 202. The patterns of railroad crossing environment 260 are merely examples of patterns that may be identified by machine learning model training and machine learning model operation to predict and/or determine blockages of the railroad crossing 202.

FIG. 2D illustrates a diagram of a railroad crossing environment 270 that illustrates signals and physical barriers that may be manipulated to reduce the likelihood of a blockage of railroad crossing 202. In one embodiment, based on infrastructure sensor data and/or based on emergency call data that is in proximity to railroad crossing 202, lights 272 and/or barriers 274 may be operated significantly earlier than typical operation times that precede the approach of a train. For example, if warning lights 272 and barriers 274 are typically operated 2 minutes prior to the approach of a train, emergency data manager may be configured to transmit one or more control signals to have the warning lights 272 and the barriers 274 to be operated 4 minutes, 10 minutes, or longer before the approach of a train, to reduce the likelihood of a blockage of railroad crossing 202 and to reduce the likelihood of a train collision at railroad crossing 202, according to an embodiment of the disclosure.

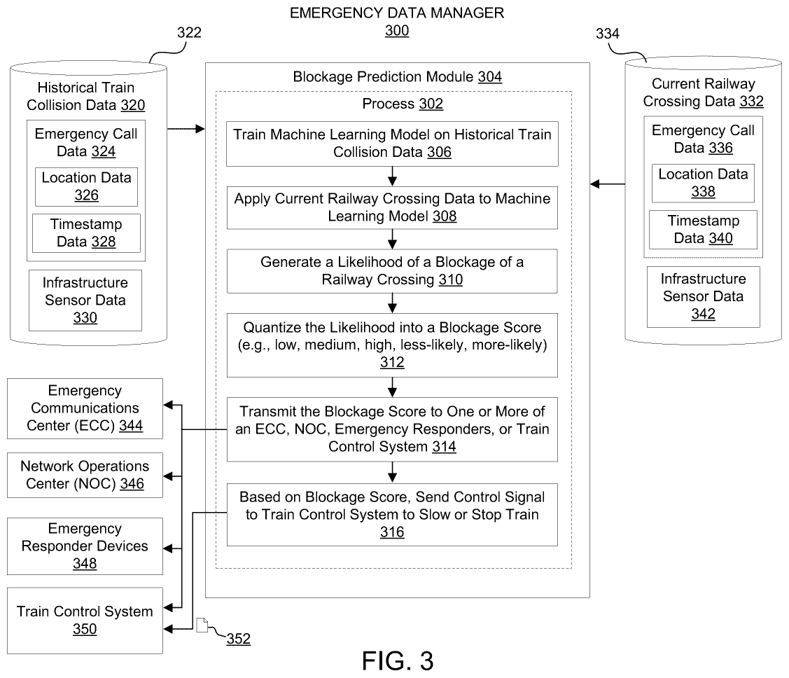

FIG. 3 illustrates a diagram of an emergency data manager 300 that is operable to perform a process 302 for determining a likelihood of a blockage of a railroad crossing, in accordance with aspects of the disclosure. Emergency data manager 300 is an example implementation of aspects of emergency data manager 100 (shown in FIG. 1). Process 302 may be executable code that is organized and/or stored as an algorithm in emergency data management 300 as a blockage prediction module 304, according to an embodiment.

The blockage prediction module 304 may be operable to request or receive historical train collision data 320 that is stored in a data structure 322 to support operation of process 302. Historical train collision data 320 may include emergency call data 324 and infrastructure sensor data 330. The emergency call data 324 may include location data 326 and timestamp data 328 that are associated with an emergency call made by a mobile device in proximity to a railroad crossing, for example.

The blockage prediction module 304 may be operable to request or receive current railroad crossing data 332 that is stored in a data structure 334 to support operation of process 302. Current railroad crossing data 332 may include emergency call data 336 and infrastructure sensor data 342. The emergency call data 336 may include location data 338 and timestamp data 340 for emergency calls made by mobile devices for one or more current incidents that are, for example, in proximity to a railroad crossing.

Process 302 includes a number of operation blocks that may be performed in the described order, in parallel, or in another order. The order in which some or all of the process operation blocks appear in process 302 should not be deemed limiting. Rather, one of ordinary skill in the art having the benefit of the present disclosure will understand that some of the process blocks may be executed in a variety of orders not illustrated, or even in parallel.

At operation 306, process 302 includes training a machine learning model on historical train collision data, according to an embodiment.

At operation 308, process 302 includes applying current railroad crossing data to the machine learning model, according to an embodiment.

At operation 310, process 302 includes generating a likelihood of a blockage of a railroad crossing, according to an embodiment. The likelihood of a blockage of a railroad crossing may be output from the machine learning model on a scale of 0-1, with 0 being very unlikely and output that is closer to 1 being more likely. More confirming evidence may result in a higher likelihood. For example, if multiple emergency calls are received that confirm patterns of historical blockages, then the likelihood may be moderately likely that a blockage exists. The likelihood may be further increased based on additional sensor data (e.g., a pressure sensor under the rails at the railroad intersection). However, a single call in proximity to a railroad crossing may be insufficient to move the likelihood (score) from low likelihood to medium or high likelihood, for example.

At operation 312, process 302 includes quantizing the likelihood into a blockage score, according to an embodiment. The blockage score may include, but is not limited to, a low risk, a medium risk, a high risk, less likely, more likely, or the like.

At operation 314, process 302 includes transmitting the blockage score to one or more of an ECC, an NOC, emergency responders, or a train control system, according to an embodiment. Transmitting the blockage score may include notifying an ECC 344, a NOC 346, emergency responder devices 348, and/or a train control system 350 of the blockage score or of another representation of a likelihood of a railroad crossing blockage. Transmitting the blockage score may include updating infrastructure EDM portal 111 through data interface 141, EDM portal 121 through data interface 149, and/or emergency responder devices 151 (e.g., over SMS) through data interface 148, for example. The notification may be a text-based message or may be a color-coded message (e.g., green—unlikely that a blockage exists, red-highly likely that a blockage exists, etc.).

At operation 316, process 302 includes, based on the blockage score, sending a control signal to the train control system to slow or stop the train, according to an embodiment. A control signal 352 may be sent to the train control system 350 to slow the train, without stopping the train, to provide additional time for the blockage to be cleared. The emergency data manager may retrieve train length and weight information to determine a stopping duration and may slow the train down or stop the train to avoid a collision between the train and the blockage. In one embodiment, the control signal 352 is sent to the train and is displayed on a user interface that a train engineer or train conductor can choose to accept or decline. Time and fuel resources for starting a train from a full-stop can be costly and can reduce the opportunity for the train to remain on schedule and on budget in the delivery of the cargo of the train.

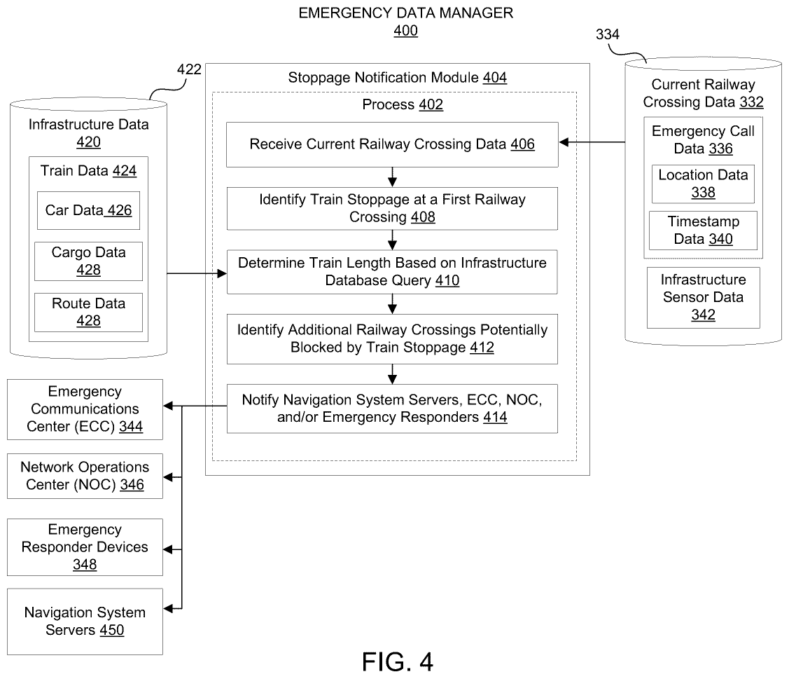

FIG. 4 illustrates a diagram of an emergency data manager 400 that is operable to perform a process 402 for identifying railroad crossings that are blocked from a train stoppage, in accordance with aspects of the disclosure. Emergency data manager 400 is an example implementation of aspects of emergency data manager 100 (shown in FIG. 1). Process 402 may be executable code that is organized and/or stored in emergency data management 400 as an algorithm and/or as a stoppage notification module 404, according to an embodiment.

The stoppage notification module 404 may be operable to request or receive current railroad crossing data 332 and infrastructure data 420 from an infrastructure information data structure 422. The infrastructure data 420 may include train data 424. The train data 424 may include car data 426 (e.g., a number or length of cars), cargo data 428 (e.g., descriptions of contents of the cars), and/or route data 428 (e.g., a direction and schedule of travel for the train).

Process 402 includes a number of operation blocks that may be performed in the described order, in parallel, or in another order. The order in which some or all of the process operation blocks appear in process 402 should not be deemed limiting. Rather, one of ordinary skill in the art having the benefit of the present disclosure will understand that some of the process blocks may be executed in a variety of orders not illustrated, or even in parallel.

At operation 406, process 402 includes receiving current railroad crossing data (e.g., from data structure 334), according to an embodiment.

At operation 408, process 402 includes identifying a train stoppage at a first railroad crossing, according to an embodiment. The train stoppage may be identified based on the emergency call data 336 and/or the infrastructure sensor data 342 (e.g., camera, pressure sensor, proximity sensor, train location sensor, etc.).

At operation 410, process 402 includes determining train length based on an infrastructure database query, according to an embodiment. Process 402 may query infrastructure information data structure 422 for the train data 424 and may determine or estimate a length of the train based on the train data 424.

At operation 412, process 402 includes identifying additional railroad crossings potentially blocked by the train stoppage, according to an embodiment. Process 402 may use one or more maps or railroad shape files to determine (at least partially based on train length) additional railroad crossings that may be blocked by a train that is stopped at a first particular railroad crossing.

At operation 414, process 402 includes notifying navigation system servers, an ECC, a NOC, and/or emergency responders of the various blocked railroad crossings, according to an embodiment. Transmitting the blocked railroad crossings may include notifying the ECC 344, the NOC 346, the emergency responder devices 348, and/or navigation system servers 450 (e.g., mobile device map and/or navigation service providers). By notifying emergency responders of railroad crossings that are blocked, emergency responders may take detours to the scene of emergency incidents without having to back-track due to not knowing about a particular railroad crossing blockage. Advantageously, by reducing the time it takes for emergency responders to arrive at the scene of an incident, lives may be saved, injuries may be reduced, property damage may be reduced, and risks to the safety of the emergency responders may be reduced, for example.

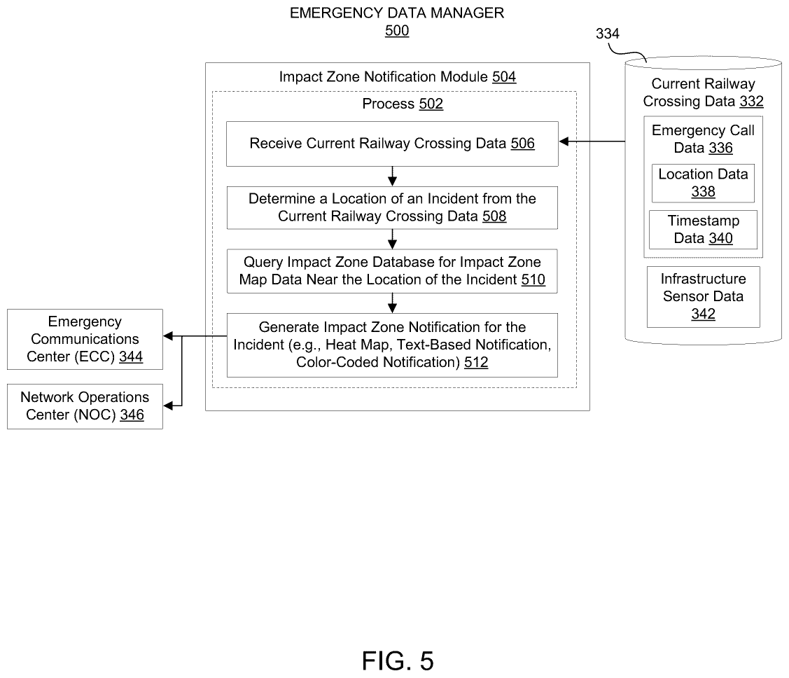

FIG. 5 illustrates a diagram of an emergency data manager 500 that is operable to perform a process 502 for generating impact zone notifications, in accordance with aspects of the disclosure. An impact zone may be defined as one or more regions where the negative impact of an incident is increased based on environmental circumstances. For example, an impact zone (for a particular ECC) may include areas that are on the outer reaches of an ECC boundary where emergency response times may be delayed based on the location of the incident being father away from emergency resources. As another example, an impact zone may include regions within an ECCs jurisdictional boundaries where emergency responders are absent (e.g., have left, are far away, etc.), so that response times may be delayed if an emergency incident occurs. As another example, an impact zone may dynamically change as emergency responders move around within an ECC's jurisdictional boundary. As another example, an impact zone may include population density (e.g., apartment complexes) or environmental features (e.g., a stream, a lake, or other natural resource) may be particularly impacted by, for example, a crash/derailment of a train (or other vehicle) carrying hazardous materials. Emergency data manager 500 is an example implementation of aspects of emergency data manager 100 (shown in FIG. 1). Process 502 may be executable code that is organized and/or stored in emergency data manager 500 as an impact zone notification module 504, according to an embodiment.

Process 502 includes a number of operation blocks that may be performed in the described order, in parallel, or in another order. The order in which some or all of the process operation blocks appear in process 502 should not be deemed limiting. Rather, one of ordinary skill in the art having the benefit of the present disclosure will understand that some of the process blocks may be executed in a variety of orders not illustrated, or even in parallel.

At operation 506, process 502 includes receiving current railroad crossing data (e.g., from data structure 334), according to an embodiment.

At operation 508, process 502 includes determining a location of an incident based on the current railroad crossing data, according to an embodiment. The location of the incident may be based on emergency call data 336 and/or infrastructure sensor data 342. Although process 502 may be used to identify impact zones that are proximate to and/or related to a railroad or train, the concepts of process 502 may be expanded to include any area within the response boundary of an ECC, in accordance with aspects of the disclosure.

At operation 510, process 502 includes querying an impact zone database for impact zone map data near the location of the incident, according to an embodiment. The impact zone database may be updated to reflect the locations of emergency responders and may include the locations of natural resources and population densities, for example.

At operation 512, process 502 includes generating impact zone notification for the incident to, for example, ECC 344 and/or NOC 346, according to an embodiment. The impact zone notification may include providing ECC 344 and/or NOC 346 with one or more of a heat map that represents cool, warm, and hot zones, a text-based notification, and/or another color scheme that visually provides information about the area around a particular incident (e.g., the area around a car accident), for example.

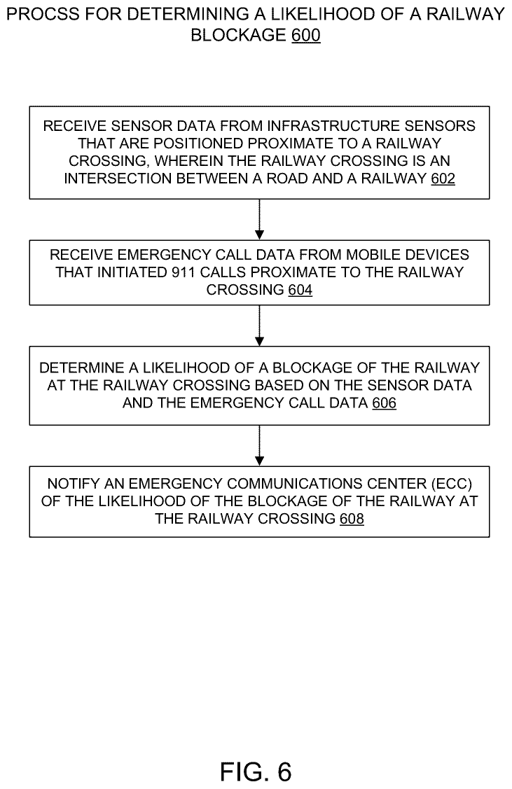

FIG. 6 illustrates a flow diagram of a process 600 for determining a likelihood of a railroad blockage, in accordance with aspects of the disclosure. Process 600 may be part of workflow logic 103. Process 600 includes a number of operation blocks that may be performed in the described order, in parallel, or in another order. The order in which some or all of the process operation blocks appear in process 600 should not be deemed limiting. Rather, one of ordinary skill in the art having the benefit of the present disclosure will understand that some of the process blocks may be executed in a variety of orders not illustrated, or even in parallel.

At operation 602, process 600 includes receiving sensor data from infrastructure sensors that are positioned proximate to a railroad crossing, according to an embodiment. The railroad crossing is an intersection between a road and a railroad, according to an embodiment.

At operation 604, process 600 includes receiving emergency call data from mobile devices that initiated 911 calls proximate to the railroad crossing, according to an embodiment.

At operation 606, process 600 includes determining a likelihood of a blockage of the railroad at the railroad crossing based on the sensor data and the emergency call data, according to an embodiment.

At operation 608, process 600 includes notifying an emergency communications center (ECC) of the likelihood of the blockage of the railroad at the railroad crossing, according to an embodiment.

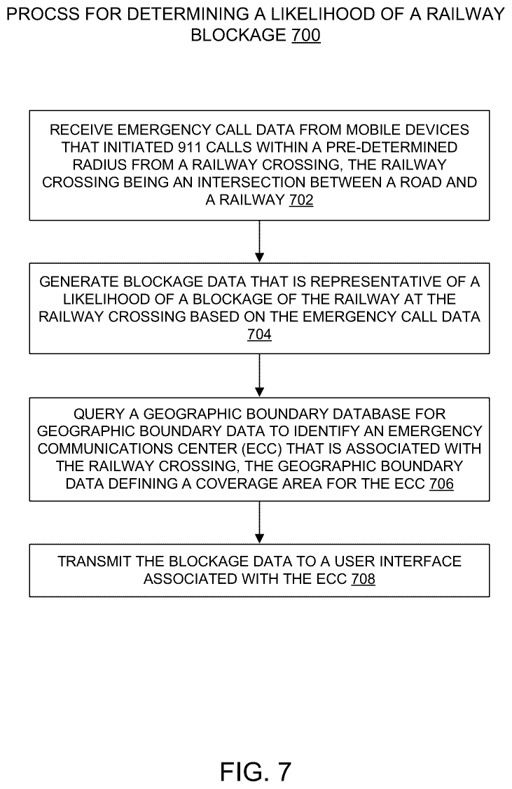

FIG. 7 illustrates a flow diagram of a process 700 for determining a likelihood of a railroad blockage, in accordance with aspects of the disclosure. Process 700 may be part of workflow logic 103. Process 700 includes a number of operation blocks that may be performed in the described order, in parallel, or in another order. The order in which some or all of the process operation blocks appear in process 700 should not be deemed limiting. Rather, one of ordinary skill in the art having the benefit of the present disclosure will understand that some of the process blocks may be executed in a variety of orders not illustrated, or even in parallel.

At operation 702, process 700 includes receiving emergency call data from mobile devices that initiated 911 calls within a pre-determined radius from a railroad crossing, the railroad crossing being an intersection between a road and a railroad, according to an embodiment.

At operation 704, process 700 includes generating blockage data that is representative of a likelihood of a blockage of the railroad at the railroad crossing based on the emergency call data, according to an embodiment.

At operation 706, process 700 includes querying a geographic boundary database for geographic boundary data to identify an emergency communications center (ECC) that is associated with the railroad crossing, the geographic boundary data defining a coverage area for the ECC, according to an embodiment.

At operation 708, process 700 includes transmitting the blockage data to a user interface associated with the ECC, according to an embodiment.

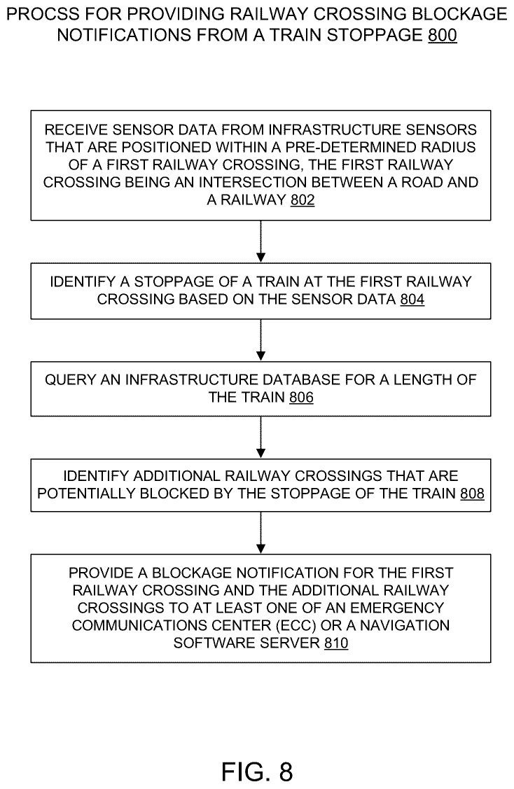

FIG. 8 illustrates a flow diagram of a process 800 for providing railroad crossing blockage notifications from a train stoppage, in accordance with aspects of the disclosure. Process 800 may be part of workflow logic 103. Process 800 includes a number of operation blocks that may be performed in the described order, in parallel, or in another order. The order in which some or all of the process operation blocks appear in process 800 should not be deemed limiting. Rather, one of ordinary skill in the art having the benefit of the present disclosure will understand that some of the process blocks may be executed in a variety of orders not illustrated, or even in parallel.

At operation 802, process 800 includes receiving sensor data from infrastructure sensors that are positioned within a pre-determined radius of a first railroad crossing, the first railroad crossing being an intersection between a road and a railroad, according to an embodiment.

At operation 804, process 800 includes identifying a stoppage of a train at the first railroad crossing based on the sensor data, according to an embodiment.

At operation 806, process 800 includes querying an infrastructure database for a length of the train, according to an embodiment.

At operation 808, process 800 includes identifying additional railroad crossings that are potentially blocked by the stoppage of the train, according to an embodiment.

At operation 810, process 800 includes providing a blockage notification for the first railroad crossing and the additional railroad crossings to at least one of an emergency communications center (ECC) or a navigation software server, according to an embodiment.

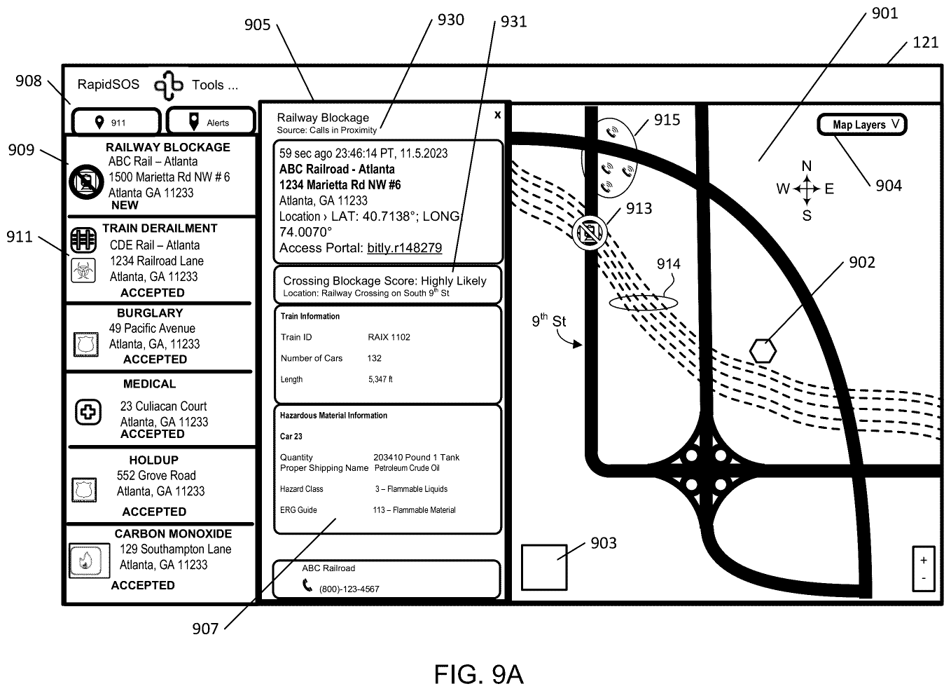

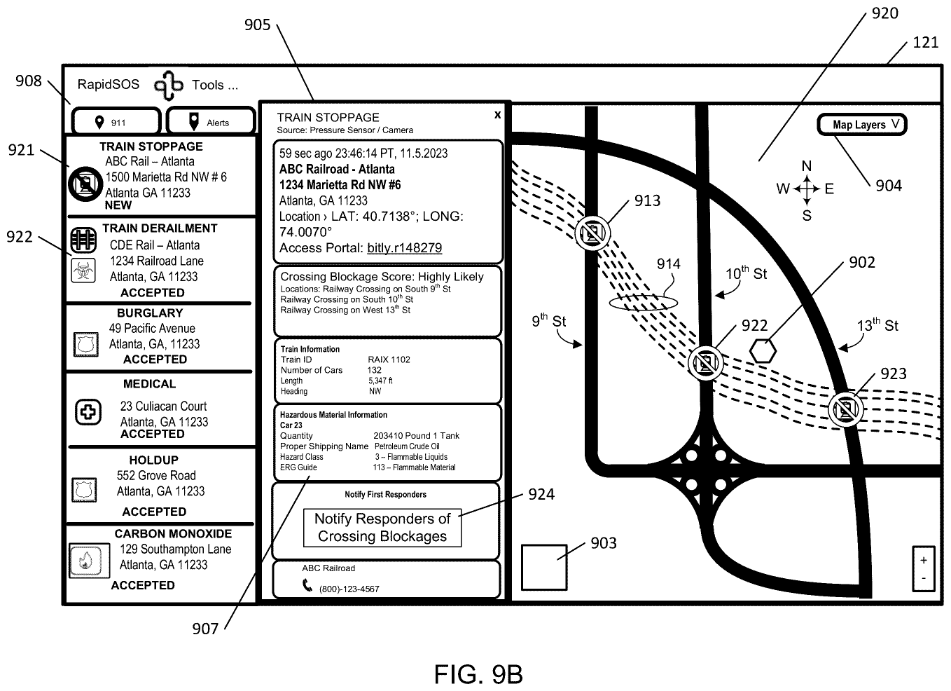

FIGS. 9A and 9B illustrate example diagrams of GUIs that may be displayed at an ECC to graphically communicate potential blockages of railroad crossings, in accordance with aspects of the disclosure. FIG. 9A is an example EDM portal 121 displayed on an ECC network entity 120 in accordance with an embodiment. The EDM portal 121 includes a map view 901 that shows an area of jurisdiction of the ECC. An area of jurisdiction refers to one or more geographic areas, having a boundary that is typically polygonal, for which the particular ECC has authority and responsibility for handling emergencies. The map view 901 may include various layers that may be turned on and off using map layers control 904. The map view 901 may also have a satellite view control 903 that may be turned on and off, as well as other controls to zoom in and zoom out of the map view 901. One or more location indicators 902 may be displayed that show emergency locations and may provide other information such as emergency type, severity, whether the emergency is being handled, etc., and this information may be provided by text, fonts, colors, icon shape and size, flashing indications, and any combination of these features.

An emergency queue is provided with various queue entries for emergencies that have been sent by the emergency data manager 100 and/or that represent incoming emergency calls, according to an embodiment. In some implementations, the operator may have selectable tabs 908 to switch between an emergency call (i.e., 9-1-1 or 1-1-2 calls) queue and an emergency alerts queue. Alert queue entries are selectable and enable display of further detailed information. For example, alert queue entry 909 is for a potential railroad blockage 913 (shown in map view 901) and may be selected to show a data card 905. The data card 905 may provide a link, such as a uniform resource locator (URL) or shortened URL that provides even more detailed information. If hazardous material is involved, the data card 905 may have a hazardous material information field 907. The data card 905 may provide the source of the information that was used to determine the likelihood of a railway blockage. For example, the source 930 may include a reference to emergency calls, sensor data, or a combination of emergency calls and sensor data. The data card 905 may provide a crossing blockage score 931 that is representative of the likelihood of a blockage. The crossing blockage score 931 may be quantized into 2, 3, or more categories. For example, if the output of a machine learning model is quantized into 2 categories, the categories may include likely and unlikely. If the output of the machine learning model is quantized into 3 categories, the categories may include low likelihood, medium likelihood, and high likelihood, for example. A scale of 1-10 may also additionally or alternatively be displayed/provided. Source 930 may also indicate whether the blockage has been verified by, for example, an artificial intelligence (AI) analysis of a camera feed or image of a railroad crossing, for example.

The map view 901 may illustrate the potential railroad blockage 913 with an icon (e.g., a train crossed out) that is next to one or more sets of railroad tracks 914. The map view 901 may also illustrate the location of a number of emergency calls 915 that are proximate to the blocked railroad crossing and that are the basis of the blockage notification. If one or more infrastructure sensors were used to identify the potential blockage, the relevant sensors may also be illustrated in the map view 901.

Each of the emergency alerts queue entries may show one or more icons that indicate the type of incident related to the entry. For example, emergency alert queue entry 909, which is for a potential railroad blockage, shows a blocked train icon. As another example, emergency alert queue entry 911, which is for a train derailment involving hazardous material, shows a train track icon and a hazardous material icon. The icons may be of any size or shape, may utilize various colors, and may be flashing. The emergency alerts queue entries also indicate if the entry has been accepted by an ECC operator, or whether the entry is new and needs to be accepted and handled.

FIG. 9B shows a map view 920 having an alert queue entry 921 for a train stoppage, in accordance with aspects of the disclosure. The map view 920 may include railroad blockage icons 922 and 923 that are associated with the railroad blockage 913 that is caused by a stopped train, for example. The data card 905 may include a button 924 that allows an operator to notify emergency responders of railroad crossing blockages (e.g., via a map or text-based description of the blocked railroad crossings).

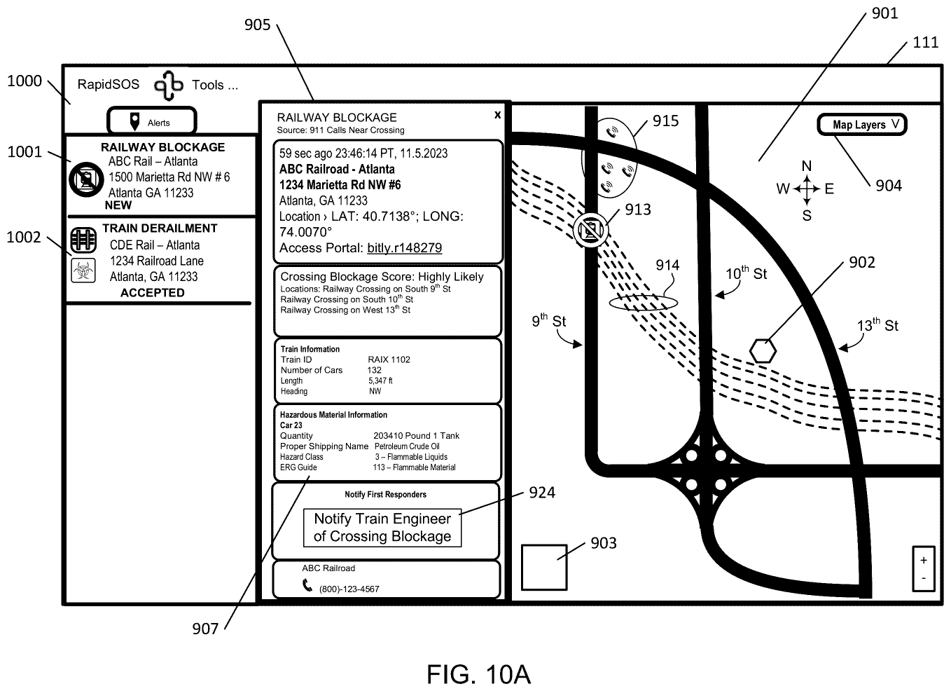

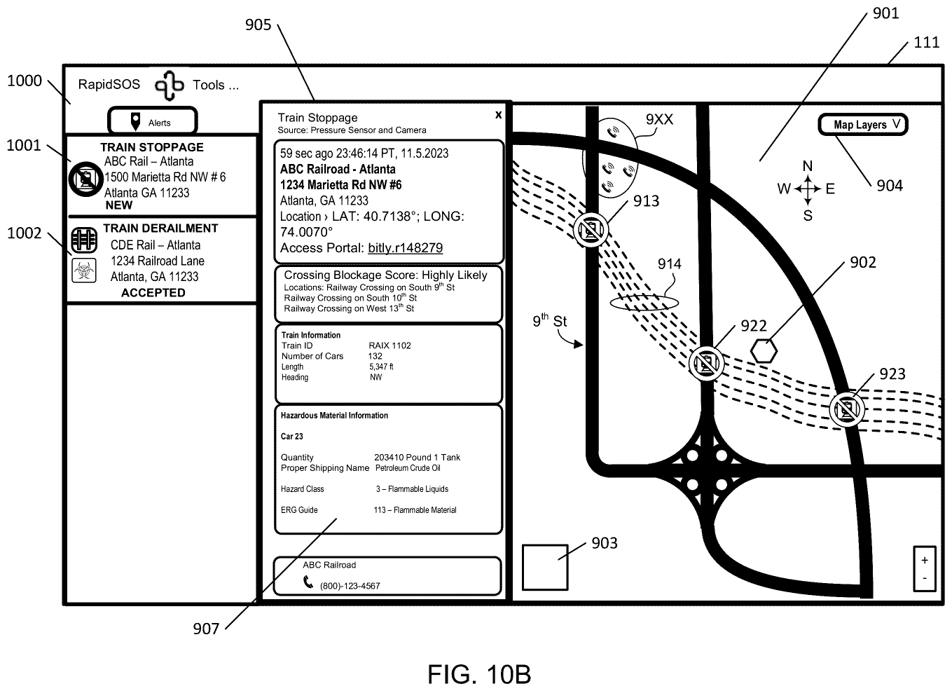

FIGS. 10A and 10B are example diagrams of the infrastructure EDM portal 111 that may be used by a NOC operator, in accordance with an embodiment. After an operator creates an incident or after the infrastructure EDM portal 111 receives an incident (e.g., from the emergency data manager 100), it will appear in an alerts queue 1000. Similar to the EDM portal 121, each of the emergency alerts queue entries in the infrastructure EDM portal 111 may show one or more icons that indicate the type of incident related to the entry. For example, if the IOC is a NOC for a railroad, the alert queue entries will be railroad related. For example, emergency alert queue entry 1001, which is for a railroad blockage, shows a blocked train icon. The second example emergency alert queue entry 1002, which is for a train derailment involving hazardous material, shows a train track icon and a hazardous material icon. Various other features of the infrastructure EDM portal 111 of FIGS. 10A and 10B may be similar to the EDM portal 121 of FIGS. 9A and 9B, according to embodiments of the disclosure.

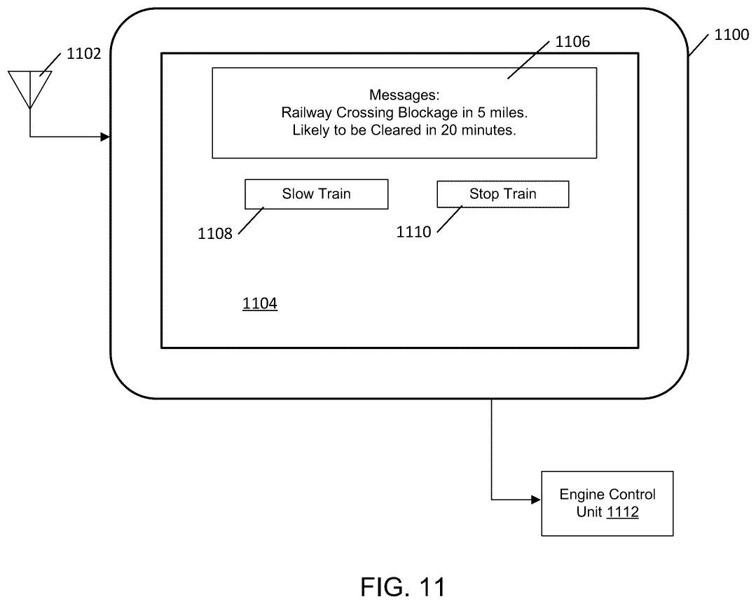

FIG. 11 illustrates a train control interface 1100 that may be part of a train control system that is used to accelerate, decelerate, start, and stop a train, in accordance with aspects of the disclosure. The train control interface 1100 may receive messages using an antenna 1102. The chain control interface 1100 may display the messages on a screen 1104. Within the screen 1104, messages may be displayed within a message box 1106 to allow a conductor or train engineer to read messages received. If an emergency data manager or a NOC transmits a control signal to slow or stop a train in response to detecting a railroad crossing blockage, menu buttons 1108 and 1110 may be displayed on the screen 1104. In one embodiment, the control signal that is transmitted to the train control system may automatically reduce the speed of the train. In one embodiment, menu buttons 1108 and 1110 are presented to the train conductor or the train engineer to allow them to slow the train or stop the train, in response to receiving a message about a railroad crossing blockage. Upon selecting one of the menu buttons 1108 or 1110, the train control interface 1100 may transmit a control signal to the engine control unit 1112 to begin decelerating the train, according to an embodiment.

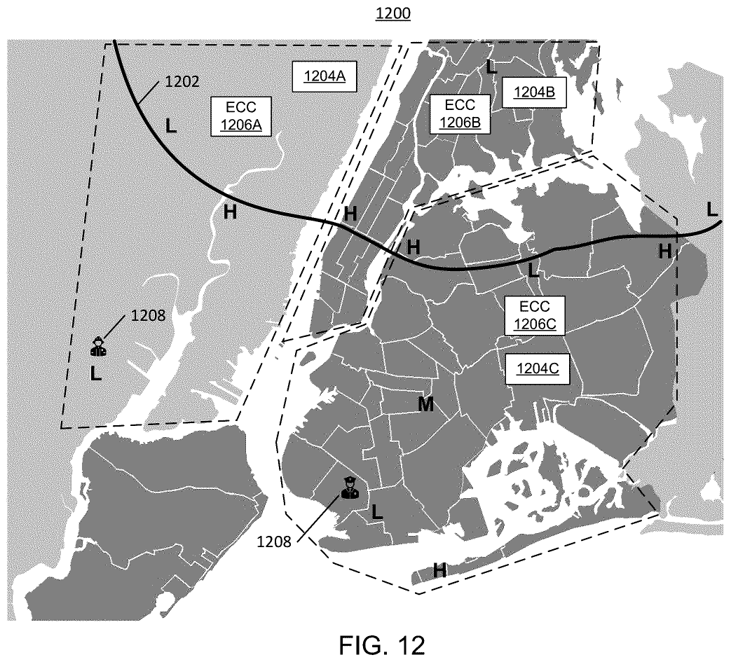

FIG. 12 illustrates a map view 1200 that shows a simplified example of a notification of impact zones along a railroad 1202 that travels along a number of jurisdictional boundaries 1204, in accordance with aspects of the disclosure. The jurisdictional boundaries 1204 correspond with a number of ECCs 1206, in accordance with aspects of the disclosure. Jurisdictional boundaries 1204 may be individually referenced as jurisdictional boundary 1204A, 1204B, and 1204C, for example. ECCs 1206 may be individually referenced as ECC 1206A, 1206B, and 1206C. Map view 1200 could be overlayed with a heat map to show high impact zones, medium impact zones, and low impact zones. To simplify, the letters H, M, L are positioned in map view 1200 to show potential high, medium, and low impact zones, respectively. For example, locations where the railroad 1202 passes near the location of an ECC are denoted as low impact zones. Additionally, where the railroad 1202 passes by rural areas may be denoted as low impact zones. Regions within the jurisdictional boundaries 1204 that are near an emergency responder 1208 are also denoted as low impact zones. However, regions within the jurisdictional boundaries 1204 where the railroad 1202 passes near high urban areas and/or streams (or other natural resources) are denoted as relatively high impact zones. The mapping of impact zones may be further complicated by tracking trends for times of the day, days of the week, and particular days of the year (e.g., holidays) and applying the trends to further mappings.

Specifically, for railroad incidents, an ECC may need to be contacted for a number of reasons, such as but not limited to, an emergency needing response from local law enforcement, fire department or emergency medical services (EMS). An ECC may also be contacted when an incident has occurred that could adversely affect the public, when a train will be blocking a crossing for an extended period of time (such as longer than 30 minutes), or when railroad police/security personnel request assistance from local law enforcement.

The presently disclosed apparatuses, systems, and methods provide information flow between ECCs and infrastructure operations centers. Specifically for railroads, the presently disclosed apparatuses, systems, and methods may provide information similar to, or in addition to, requirements as set forth in the NENA Public Safety Communications & Railroad Interaction Standard Operating Procedures, NENA-STA-013.2-20116 (Mar. 31, 2016).

For example, the emergency data manager 100 may provide an ECC with address, street, community, landmark, longitude, and latitude, etc. The emergency data manager 100 may provide information as to whether a single railcar or multiple railcars were involved in an incident, whether the train involved is still moving or will be stopping, and the planned stop location; the current location of the engine and involved railcars; the current location of the conductor; and the current location of any non-rail vehicles.

Further, the emergency data manager 100 may provide information regarding whether any railroad crossings are blocked, estimates of how long grade crossings will be blocked, effected waterways and how they are affected, whether the incident is near a municipality or in a rural area, additional hazards adjacent or within proximity of the incident such as, but not limited to, chemical plants, public facilities, public access areas, visible overhead facilities or structures that may be impacted, barriers to reaching the incident scene that responders need to be aware of, conditions of the tracks, such as but not limited to electrified or damaged rails, etc.

The emergency data manager 100 may also provide information as to the type of incident such as, but not limited to the type of response requested such as law enforcement, fire, medical, or hazmat, including the nature and type of incident. For railroads, these may include derailment, train versus motor vehicle, train versus pedestrian/trespasser, fire, hazardous chemicals leak, criminal activity, medical emergency, type of train, estimated number of passengers onboard for passenger trains, freight, consist/manifest information for freight trains, and any other needed information such as track maintenance vehicles or equipment, any known injuries, estimated number and extent of injuries, etc.

In other words, the emergency data manager 100 provides information and communication between ECCs and infrastructure operations centers to handle emergency situations protecting the emergency responders and the public by providing the emergency responders with critical information, such as but not limited to hazardous material information, so that the proper handling procedures can be put into operation as quickly as possible, without unnecessary confusion or delays, to save the lives and health of the public while also protecting the emergency responders from the associated risks.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. An emergency management system comprising:
a cloud server, comprising a network component and at least one processor, operatively coupled to the network component, the at least one processor, operative to:
receive sensor data from infrastructure sensors that are positioned proximate to a railroad crossing, wherein the railroad crossing is an intersection between a road and a railroad;
receive emergency call data from mobile devices that initiated 911 calls proximate to the railroad crossing;
determine a likelihood of a blockage of the railroad at the railroad crossing based on the sensor data and the emergency call data; and
notify an emergency communications center (ECC) of the likelihood of the blockage of the railroad at the railroad crossing.

2. The emergency management system of claim 1, wherein the infrastructure sensors include at least one of: cameras, pressure sensors, power line sensors, water pressure sensors, moisture detection sensors, or proximity sensors.

3. The emergency management system of claim 1, wherein the at least one processor is further operative to:
receive emergency call data location data and timestamp data for each of the mobile devices, wherein the emergency call data excludes audio voice data.

4. The emergency management system of claim 1, wherein the at least one processor is further operative to:
receive sensor data from infrastructure sensors that are positioned proximate to a railroad crossing, within a radius of up to 500 meters from a center of the railroad crossing.

5. The emergency management system of claim 1, wherein the at least one processor is further operative to:
determine a likelihood of a blockage of the railroad at the railroad crossing based on the sensor data detecting a vehicle positioned on or between tracks of the railroad.

6. The emergency management system of claim 1, wherein the at least one processor is further operative to:
determine a likelihood of a blockage of the railroad at the railroad crossing based on the sensor data detecting a vehicle positioned within two feet of tracks of the railroad.

7. The emergency management system of claim 1, wherein the at least one processor is further operative to:
provide a data interface from the cloud server to an ECC network entity; and
send an infrastructure message to the ECC to initiate train collision avoidance protocols, wherein the infrastructure message includes the likelihood of the blockage of the railroad at the railroad intersection.

8. The emergency management system of claim 7, wherein the at least one processor is further operative to:
provide an instance of a cloud application to the ECC via an emergency data manager portal; and
notify an ECC, wherein the ECC is a network operations center (NOC) or a public safety answering point (PSAP) that includes an infrastructure management application or an emergency data manager portal.

9. The emergency management system of claim 1, wherein the at least one processor is further operative to:
initially detect a potential blockage of the railroad based on the emergency call data;
request the sensor data from some of the infrastructure sensors;
verify the potential blockage of the railroad based on the sensor data; and
update the likelihood of the blockage of the railroad.

10. The emergency management system of claim 9, wherein the at least one processor is further operative to:
quantize the likelihood of the blockage into a low level, a medium level, and a high level; and
set likelihood of the blockage to the high level in response to verification of the potential blockage based on the infrastructure sensor data.

11. The emergency management system of claim 1, wherein the at least one processor is further operative to:
apply the sensor data and the emergency call data to a machine learning model to determine the likelihood of the blockage of the railroad.

12. The emergency management system of claim 11, wherein the at least one processor is further operative to:
train the machine learning model to determine the likelihood of the blockage of the railroad with historical data for train collisions.

13. The emergency management system of claim 12, wherein the historical data for the train collisions comprises historical emergency call data patterns initiated in proximity to railroad crossings that had some of the train collisions.

14. The emergency management system of claim 13, wherein the historical data for the train collisions comprises historical sensor data for some of the infrastructure sensors.

15. The emergency management system of claim 1, wherein the at least one processor is further operative to:
quantize a numeric representation of the likelihood of the blockage of the railroad into two or more risk categories.

16. The emergency management system of claim 1, wherein the at least one processor is further operative to:
determine that the likelihood of the blockage exceeds a pre-determined threshold; and
send a control signal to decelerate a train from an initial speed, wherein the train is in-bound to the railroad crossing.

17. The emergency management system of claim 16, wherein the at least one processor is further operative to:
send the control signal is to decelerate a train without stopping the train, to reduce a quantity of time used to return the train to the initial speed.

18. The emergency management system of claim 1, wherein the at least one processor is further operative to:
identify a stoppage of a train at the railroad crossing;
search an infrastructure database for a length of the train;
identify additional railroad crossings that are potentially blocked by the stoppage of the train; and
provide a blockage notification for the railroad crossing and the additional railroad crossings to at least one of the ECC or a navigation software server.

19. A method comprising:
receiving emergency call data from mobile devices that initiated 911 calls within a pre-determined radius from a railroad crossing, the railroad crossing being an intersection between a road and a railroad;
generating blockage data that is representative of a likelihood of a blockage of the railroad at the railroad crossing based on the emergency call data;
querying a geographic boundary database for geographic boundary data to identify an emergency communications center (ECC) that is associated with the railroad crossing, the geographic boundary data defining a coverage area for the ECC; and
transmitting the blockage data to a user interface associated with the ECC.

20. The method of claim 19, wherein the emergency call data include location data and timestamp data for the mobile devices during the 911 calls, wherein generating the blockage data includes applying the emergency call data to a machine learning model, wherein output of the machine learning model includes the blockage data.

21. The method of claim 19, further comprising:
query at least one infrastructure database for sensor data from infrastructure sensors that are positioned within the pre-determined radius of the railroad crossing; and
updating the likelihood of the blockage of the railroad based on the sensor data.

22. The method of claim 21, wherein the infrastructure sensors include at least one of: cameras, pressure sensors, power line sensors, water pressure sensors, moisture detection sensors, or proximity sensors.

23. A method comprising:
receiving sensor data from infrastructure sensors that are positioned within a pre-determined radius of a first railroad crossing, the first railroad crossing being an intersection between a road and a railroad;
identifying a stoppage of a train at the first railroad crossing based on the sensor data;
querying an infrastructure database for a length of the train;
identifying additional railroad crossings that are potentially blocked by the stoppage of the train; and
providing a blockage notification for the first railroad crossing and the additional railroad crossings to at least one of an emergency communications center (ECC) or a navigation software server.

24. The method of claim 23, wherein the ECC is a network operations center (NOC) or a public safety answering point (PSAP), wherein the navigation software server is operable to provide mobile devices with traffic updates and map-based navigation services.
